(19) United States
(12) Patent Application Publication
(10) Pub. No.: US 2007/0088494 A1
(43) Pub. Date: Apr. 19, 2007

(54) System and method for enabling wireless traffic message passing

(76) Inventors: Michael A. Rothman, Puyallup, WA (US); Vincent J. Zimmer, Federal Way, WA (US)

Correspondence Address: INTEL/BLAKELY, 12400 WILSHIRE BOULEVARD, SEVENTH FLOOR, LOS ANGELES, CA, 90025-1030, US

(21) Appl. No.: 11/541,409

(22) Filed: Sep. 28, 2006

Related U.S. Application Data
(63) Continuation-in-part of application No. 10/882,029, filed on Jun. 29, 2004, now Pat. No. 7,117,083.

(51) Int. Cl. G08G 1/00; G01C 21/32

(52) U.S. Cl. 701/200; 701/117; 701/211

(57) ABSTRACT

A system and method for enabling wireless traffic message passing. The method includes initializing a vehicle wireless subsystem, enabling a vehicle wireless subsystem comprising a WiMAX transponder to broadcast a query to request real-time traffic pattern data from a WiMAX tower, and if a response to the query is received, incorporating the real-time traffic pattern data into a runtime database and creating a human-readable display for displaying the runtime database on a navigation system. The human-readable display of the traffic pattern data includes the display of free-flowing traffic, slow moving traffic, and stopped traffic on a map to allow the driver to change a planned travel route if slow and stopped traffic pattern conditions exist on the planned travel route.

This application is a continuation-in-part of U.S. patent application Ser. No. 10/882,029 filed Jun. 29, 2004.

### BACKGROUND OF THE INVENTION

1. Field of the Invention

Embodiments of the present invention are generally related to the field of intelligent highway systems. More particularly, embodiments of the present invention are related to a system and method for the dissemination of traffic conditions on the highway.

2. Description

Currently many vehicles are being manufactured to include navigation systems. The current state of navigation systems in vehicles is based on fixed maps using a GPS (Global Positioning System) to determine where the vehicle is located. The navigation system provides a user, while in the vehicle, with directions to be able to traverse streets, roads, and highways to get from point A to point B without much hassle. Some of the things that are not available today with navigation systems are (1) whether there is going to be congested traffic up ahead, (2) whether there are any road closures involved, (3) whether there are any detours ahead, or (4) any other obstacles that would prevent a driver from getting to his/her destination in a timely manner.

Currently, drivers cannot determine whether there is upcoming traffic congestion or some other type of road condition without having to listen to an appropriate traffic report on a radio station. Often times, even if the driver is able to hear the traffic report on the radio, it is at random whether the driver will be able to obtain the traffic information that the driver needs at the time the driver needs it (i.e., prior to already being in the location of the traffic jam).

On Dec. 17, 2003, the Federal Communications Commission (FCC) approved an Intelligent Transportation Systems (ITS) initiative that provides for a new signal frequency of 5.9 GHz (Giga Hertz) to be used for Intelligent Highways. See, http://hraunfoss=fcc=gov/edocs_public/attachmatch/DOC-242309A1=pdf. (It should be noted that periods have been replaced with equal signs in URLs within this document to avoid inadvertent hyperlinks.) The Intelligent Transportation Systems (ITS) initiative is intended for interstate highways as well as vehicles to have wireless transponders with an effective radius of roughly 100 yards that will enable the ability of a vehicle to know when to put brakes on to avoid a crash or when another vehicle is approaching. Thus, this initiative is basically a public safety measure where vehicles will be aware of what's going on immediately around them and highways, or at least interstates, will have transponders that will interact with all of the vehicles that pass by the transponders. This will allow a vehicle to have knowledge such as whether some other vehicle is coming up very quickly behind it, whether it is safe to change lanes, etc. The installation of the equipment for Intelligent Highways is expected to occur within the next five (5) years.

Although Intelligent Highways will provide public safety measures and alerts, such as collision avoidance, work zone warnings, or other road condition warnings, Intelligent Highways will not be able to provide traffic pattern data regarding highway congestion issues.

Thus, what is needed is a system and method for disseminating upcoming traffic conditions on highways to drivers. What is also needed is a system and method for disseminating real-time traffic pattern information regarding highway traffic conditions by augmenting a pre-existing short-range communication environment and vehicle navigation systems. What is further needed is a system and method that provides real-time traffic pattern information regarding highway traffic conditions to enable a driver to make appropriate choices in the selection of optimal travel routes.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an embodiment of an exemplary Intelligent Highway.

FIG. 2A is a diagram illustrating an exemplary method for passing locality status data from one highway transponder to another according to an embodiment of the present invention.

FIG. 2B is a diagram illustrating an exemplary method for passing locality status data from one vehicle to another according to an embodiment of the present invention.

FIG. 3 is a diagram illustrating an exemplary map from a vehicle navigation system showing traffic patterns received from peer-to-peer communications according to an embodiment of the present invention.

FIG. 4A is an exemplary type definition structure for a highway to vehicle packet according to an embodiment of the present invention.

FIG. 4B is an exemplary type definition structure for a vehicle to highway packet according to an embodiment of the present invention.

FIG. 5 is a flow diagram describing an exemplary method for real-time traffic information management by a vehicle wireless subsystem according to an embodiment of the present invention.

FIG. 6 is a flow diagram describing an exemplary method for real-time traffic information management by a highway transponder wireless subsystem according to an embodiment of the present invention.

FIG. 7 is a block diagram of an exemplary WiMAX deployment according to an embodiment of the present invention.

FIG. 8 is a block diagram illustrating another embodiment of an exemplary Intelligent Highway.

FIG. 9 is a diagram illustrating an exemplary method for passing locality status data from one vehicle to another according to an embodiment of the present invention.

FIG. 10 is a diagram further illustrating methods of operation for an intelligent highway according to an embodiment of the present invention.

FIG. 11A is an exemplary type definition structure for a WiMax-to-vehicle packet according to an embodiment of the present invention.

FIG. 11B is an exemplary type definition structure for a vehicle-to-WiMax packet according to an embodiment of the present invention.

FIG. 12 is a flow diagram describing another exemplary method for real-time traffic information management by a vehicle wireless subsystem according to an embodiment of the present invention.

FIG. 13 is a flow diagram describing an exemplary method for real-time traffic information management by a WiMax tower according to an embodiment of the present invention.

FIG. 14 is another flow diagram describing an exemplary method for real-time traffic information management by a WiMax tower according to an embodiment of the present invention.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a system and method for disseminating real-time highway traffic information to vehicle drivers. Embodiments of the present invention leverage Intelligent Highways and navigation systems to provide drivers with the ability to make appropriate choices in the selection of optimal travel routes. This is accomplished by using peer-to-peer dissemination of real-time traffic data. The real-time traffic data may be passed from a vehicle to a highway marker, from a highway marker to a vehicle, from a highway marker to another highway marker, from one vehicle to another vehicle, from a vehicle to a WiMax tower, and from a WiMax tower to a vehicle. The real-time traffic data may be incorporated into a vehicle navigation system to intelligently re-route the travel route of a driver based on traffic conditions.

Although embodiments of the present invention are described for highways, the invention is not limited to highways. One skilled in the relevant art(s) would know that the invention is equally applicable to streets and roads having transponders capable of peer-to-peer communications and/or WiMax capability.

Embodiments of the present invention are described as being implemented by leveraging pre-existing short-range and medium range communication environments used in Intelligent Highways and current vehicle navigation systems. One skilled in the relevant art(s) would know that embodiments of the present invention may also be implemented using other types of wireless communication systems and/or vehicle navigation systems as well.

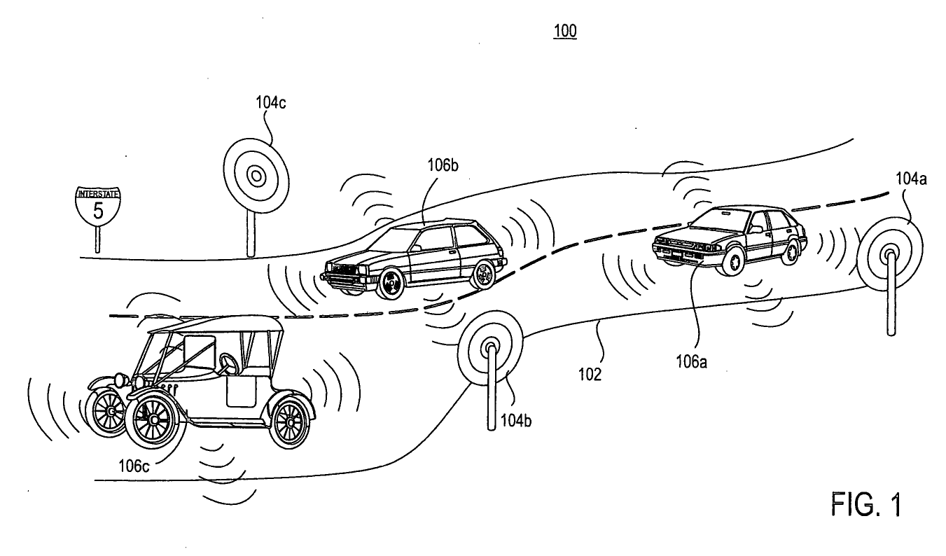

FIG. 1 is a block diagram illustrating an embodiment of an exemplary Intelligent Highway 100. Intelligent Highway 100 comprises a highway 102 with a plurality of highway transponders 104a, 104b, and 104c (also referred to as highway markers) spaced at pre-determined distances along highway 102. For example, an FCC Intelligent Transportation System initiative indicates that each transponder may have an effective radius of approximately 100 yards. Therefore, highway transponders 104a, 104b, and 104c may be spaced at approximately 100 yard distances apart for transponders located on the same side of the road. Highway 102 also includes vehicles 106a, 106b, and 106c traveling along highway 102. Each of vehicles 106a, 106b, and 106c may also include transponders 104d, 104e, and 104f (not explicitly shown) located within vehicles 106a, 106b, and 106c that are capable of communicating with transponders 104a, 104b, and 104c.

As previously indicated, embodiments of the present invention enable peer-to-peer communications between vehicular transponders and highway transponders. Each highway transponder 104a, 104b, and 104c is capable of transmitting and receiving traffic data to and from each vehicle transponder 104d, 104e, and 104f as each vehicle 106a, 106b, and 106c passes by, or comes in contact with, each highway transponder 104a, 104b, and 104c. For example, as vehicle 106a passes highway transponder 104a, vehicle 106a may request that highway transponder 104a provide it with current traffic information stored on highway transponder 104a. Also, highway transponder 104a may request that vehicle 106a provide it with current traffic information stored on vehicle 106a.

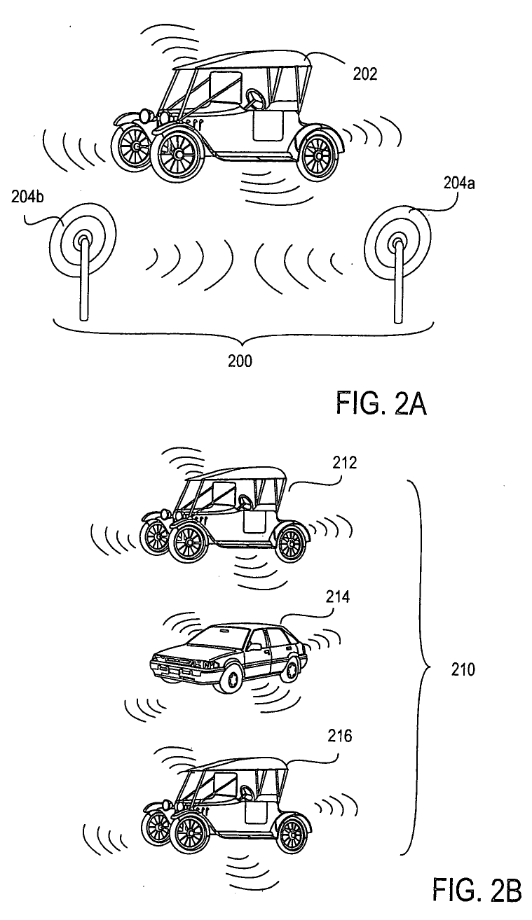

Peer-to-peer communications may also occur between highway transponders. FIG. 2A is a diagram 200 illustrating an exemplary method for passing locality status data from one highway transponder to another according to an embodiment of the present invention. Diagram 200 shows a vehicle 202 and two highway transponders 204a and 204b. If highway transponders 204a and 204b are located within a predetermined radius that enables highway transponders 204a and 204b to communicate, then highway transponders 204a and 204b may pass traffic data information to each other. For example, if highway transponder 204b has passed traffic data information to highway transponder 204a, when vehicle 202 passes highway transponder 204a, vehicle 202, after requesting traffic data information from highway transponder 204a, will know about traffic data information on highway transponder 204b even though vehicle 202 has not come in contact with highway transponder 204b. In one embodiment, a highway transponder may collect data from other highway transponders located north and south as well as east or west of the highway transponder. Therefore, when a vehicle passes a highway transponder, the highway transponder may provide traffic information of interest to vehicles traveling in all directions (i.e., north, south, east, and west).

Peer-to-peer communications may also occur between vehicles by way of vehicle transponders. FIG. 2B is a diagram 210 illustrating an exemplary method for passing locality status data from one vehicle to another according to an embodiment of the present invention. Diagram 210 shows three vehicles 212, 214, and 216 passing traffic data information from one vehicle to another. For example, vehicle 212 is shown passing traffic data information to vehicle 214. Vehicle 214 is shown passing traffic data information to vehicles 212 and 216. Vehicle 216 is shown passing traffic data information to vehicle 214. Thus, vehicle 212 may pass information to vehicle 214 and vehicle 214 may pass information from both vehicles 212 and 214 to vehicle 216. Also, vehicle 216 may pass information to vehicle 214 and vehicle 214 may pass information from both vehicles 216 and 214 to vehicle 212.

By using peer-to-peer dissemination of data, a driver can receive traffic data information when not on a highway. For example, if one vehicle has just left the highway onto a side street while another vehicle is on the same side street headed in the direction of the highway, their peer-to-peer communication will provide the vehicle heading toward the highway with traffic information without ever having driven onto the highway. The driver of the vehicle headed toward the highway will be provided with traffic data information prior to his/her arrival on the highway, and may decide to take an alternate route if the traffic data information indicates that traffic conditions on the highway are congested.

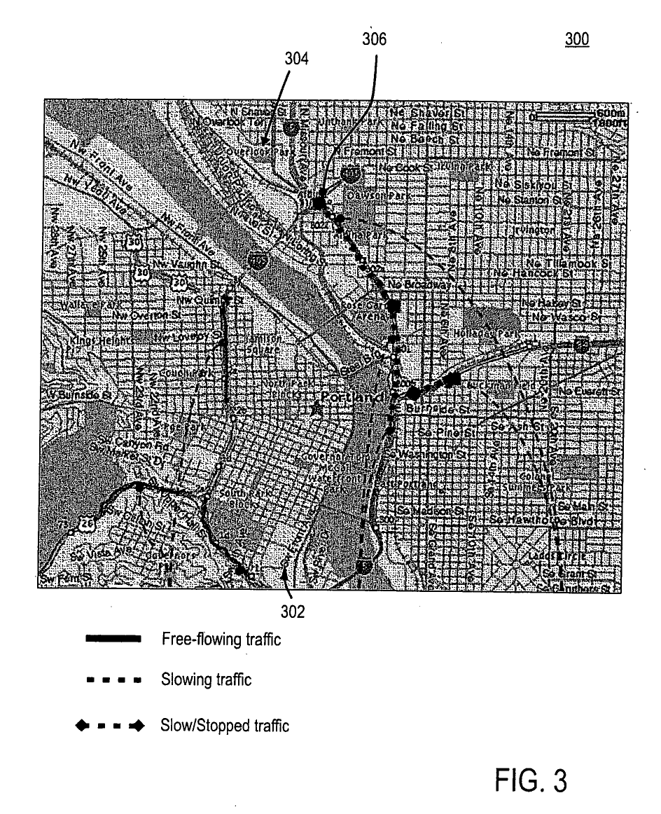

As previously indicated, the peer-to-peer communications described in detail above may be incorporated on vehicle navigation systems to provide drivers with real-time traffic information to enable drivers to intelligently re-route their course based on traffic conditions. FIG. 3 is a diagram illustrating an exemplary map 300 from a vehicle navigation system displaying traffic patterns received from peer-to-peer communications according to an embodiment of the present invention. Map 300 shows free flowing traffic, slowing traffic, and slow/stopped traffic on highways in the state of Oregon. Map 300 identifies free-flowing traffic using a thick solid line, slowing traffic using a thick dotted line, and slow/stopped traffic using a thick dotted line surrounded by diamonds on each end.

A driver leaving from SW Front Avenue (identified on map 300 as 302) going north with a destination of Overlook Park (identified on map 300 as 304) may have initially charted a path to Overlook Park 304 using Route 5 heading north. Assuming that the driver has received traffic information from vehicles traveling southbound, coming off of Route 5 and Route 405 prior to the driver's travel onto Route 5, the driver will have information regarding highway conditions for both Route 5 and Route 405 as shown in FIG. 3. After viewing the traffic information received from peer-to-peer communications with other vehicles as well as highway transponders on the vehicle navigation system, the driver is alerted to the fact that using Route 5 will slow his pace considerably. Map 300 indicates that Route 5 is plagued with slowing traffic as well as slow/stopped traffic. The driver is also alerted to the fact that the traffic on Route 405 heading north is free flowing. At the intersection where Route 5 and Route 405 cross (indicated on map 300 as 306), the driver is also alerted that the traffic on Route 5 northbound at this point is free flowing. The driver may then re-route his path to take Route 405 going north and then take Route 5 going north at the intersection where Route 405 and Route 5 cross (i.e., 306). Thus, by populating the map on the vehicle navigation system with the peer-to-peer communications shared amongst vehicles and highway transponders, drivers are able to intelligently re-route their travel route to their destination.

The amount of data any one highway or vehicle transponder may be able to store depends on the size of the memory associated with the transponder. In one embodiment, highway transponders may have equal or smaller memory capacities than vehicle transponders. In another embodiment, vehicle transponders may have equal or smaller memory capacities than highway transponders. In one embodiment, the highway transponders may be able to store data from 100 highway and vehicle transponders while the vehicle transponders may be able to store data from 100 or more highway and vehicle transponders. In another embodiment, the vehicle transponders may be able to store data from 100 highway and vehicle transponders while the highway transponders may be able to store data from 100 or more highway and vehicle transponders. In yet other embodiments, each transponder may be able to store data from 1000 or more transponders, 10,000 or more transponders, 100,000 or more transponders, etc. Thus, the limit regarding how much storage capability each transponder may have is implementation specific.

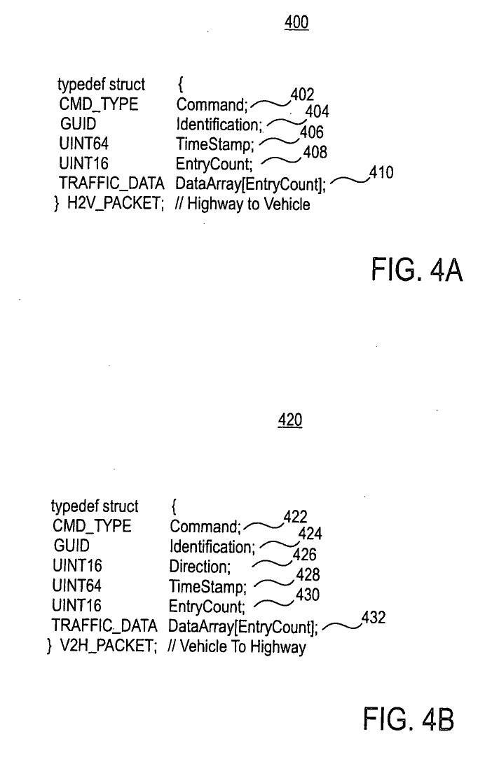

FIG. 4A is an exemplary type definition structure for a highway to vehicle packet 400 according to an embodiment of the present invention. As its name implies, highway to vehicle packet 400 contains data from a highway transponder that is being sent to a vehicle transponder. The vehicle transponder then sends the information to a navigation system database to update a map, such as map 300, which displays the traffic patterns on the navigation system. In embodiments, highway to vehicle packet 400 may be used to transfer data between highway transponders as well.

In one embodiment, highway to vehicle packet 400 includes a command 402, an identifier 404, a timestamp 406, an entry count 408, and a data array 410. Command 402 may be, but is not limited to, a read or write command. For example, a highway transponder may request to read data from a vehicle transponder or to write data to a vehicle transponder. Identifier 404 may be a unique identifier, such as, but not limited to, a GUID (Globally Unique Identifier), that identifies the highway transponder sending highway to vehicle packet 400. GUIDs are well known to those skilled in the relevant art(s). Timestamp 406 may be the time at which the request is being made. Entry count 408 may refer to the number of entries that are being sent in data array 410. For example, if a highway transponder has 20 entries from other highway transponders and vehicle transponders, entry count 408 will be 20. If the highway transponder has 100 entries from other highway transponders and vehicle transponders, entry count 408 will be 100. Data array 410 comprises an array of data that stores the traffic information retrieved from other highway transponders and vehicle transponders. In one embodiment, data array 410 may include a timestamp indicating when the data from a particular highway or vehicle transponder was initially retrieved. Including a timestamp with each entry of data enables data retrieved before a specific time to be purged from the database, thereby enabling the navigation system to map current data. Although highway to vehicle packet 400 is described containing five entries (402, 404, 406, 408, 410), these entries are provided as examples only. One skilled in the relevant art(s) would know that highway to vehicle packet 400 may contain more or less entries, as well as different types of entries, than those indicated above.

FIG. 4B is an exemplary type definition structure for a vehicle to highway packet 420 according to an embodiment of the present invention. As its name implies, vehicle to highway packet 420 contains data from a vehicle transponder that is being sent to a highway transponder. In embodiments, vehicle to highway packet 420 may be used to transfer data between vehicle transponders as well.

Vehicle to highway packet 420 is very similar to highway to vehicle packet 400 with the exception of a direction field. In one embodiment, vehicle to highway packet 420 includes a command 422, an identifier 424, a direction 426, a timestamp 428, an entry count 430 and a data array 432. Command 422 may be, but is not limited to, a read or write command. For example, a vehicle transponder may request to read data from a highway transponder or to write data to a highway transponder. Identifier 424 may be a unique identifier, such as, but not limited to, a GUID, that identifies the vehicle transponder sending vehicle to highway packet 420. Direction 426 may be the direction in which the vehicle is traveling. Timestamp 428 may be the time at which the request is being made. Entry count 430 may refer to the number of entries that are being sent in data array 432. Data array 432 comprises an array of data that stores the traffic information retrieved from other highway transponders and vehicle transponders. In one embodiment, data array 432 may include a timestamp indicating when the data from a particular highway or vehicle transponder was initially retrieved. As indicated above, including a timestamp with each entry of data enables data retrieved before a specific time to be purged from the database, thereby enabling the highway transponder to contain current data. Although vehicle to highway packet 420 is described containing six entries (422, 424, 426, 428, 430, and 432), these entries are provided as examples only. One skilled in the relevant art(s) would know that vehicle to highway packet 420 may contain more or less entries, as well as different types of entries, than those indicated above.

Embodiments of the present invention include logic for monitoring traffic information within a vehicle and logic for monitoring traffic information within a highway transponder. Prior to describing embodiments for monitoring traffic information for vehicles as well as highway transponders, the minimum granularity to determine the location of a vehicle and highway time vs. vehicle time will be discussed.

Assuming that a highway transponder has a 1 GHz clock, the minimum granularity by which the location of a vehicle may be determined is shown in equation (1) below.
Dₘᵢₙ=c*5,280/frequency=186,282*5,280/1*10⁹=0.98 ft.≈12 inches (1)
where: c is the speed of light (which is effectively the speed at which the packet travels);
   frequency is the 1 GHz, corresponding to the 1 GHz clock.
      Thus, based on the information obtained from a vehicle, the highway transponder can determine within a foot the approximate location of a car. This allows the highway transponder to provide safety provisions, such as whether a car is approaching another car too quickly, whether it is safe to change lanes, etc.

Since cars may not necessarily have their clocks set for the correct time, vehicle time may be set using a highway transponder. The time that has elapsed for a signal to travel from a vehicle to a highway transponder is hₜᵢₘₑ−Vₜᵢₘₑ=Δtime, where hₜᵢₘₑ is highway time and vₜᵢₘₑ is vehicle time. The total distance therefore being D=Δtime*Dₘᵢₙ.

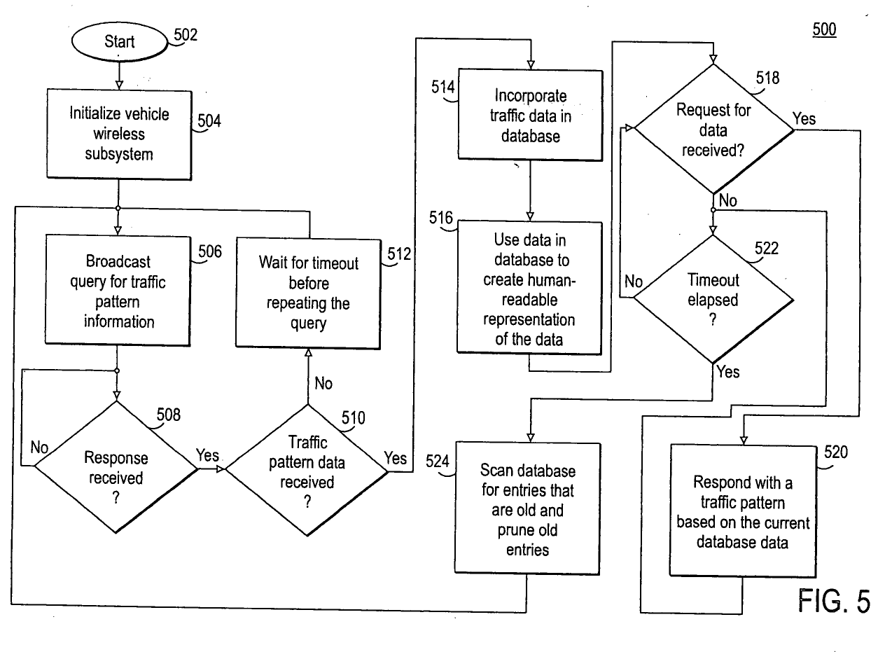

FIG. 5 is a flow diagram 500 describing an exemplary method for real-time traffic information management by a vehicle wireless subsystem according to an embodiment of the present invention. The invention is not limited to the embodiment described herein with respect to flow diagram 500. Rather, it will be apparent to persons skilled in the relevant art(s) after reading the teachings provided herein that other functional flow diagrams are within the scope of the invention. The process begins with block 502, where the process immediately proceeds to block 504.

In block 504, on starting a vehicle, the vehicle's wireless subsystem, which may include, inter alia, a wireless transponder coupled to a GPS navigation system, is initialized. The initialization process is similar to a computer booting up. The vehicle's infrastructure is turned on and a self-test may be performed. The display for the navigation system may display a start-up screen. The components in the system may be checked to determine if they are working properly. The operating system is booted up as well. Also, files that are considered stale or old, may be removed. The process then proceeds to block 506.

In block 506, a query to obtain traffic pattern information is broadcasted. During this time, the vehicle is searching for any information regarding highway traffic patterns from other vehicles as well as highway transponders, if the vehicle is on the highway.

In decision block 508, it is determined whether a response to the query has been received. Initially, there might not be any vehicles that can provide highway traffic information. In this instance, the process remains at decision block 508 until a response is received. Eventually, the vehicle will come in contact with another vehicle or a highway transponder that will provide it with a response. When a response is received, the process proceeds to decision block 510.

In decision block 510, it is determined whether the response was traffic pattern data. If the response was not traffic pattern data, the process proceeds to block 512, where the process waits for a predetermined timeout before proceeding back to block 506, where another query is broadcasted.

Returning to decision block 510, if it is determined that the response was traffic pattern data, the process proceeds to block 514. In block 514, the traffic pattern data is incorporated into a runtime database for the vehicle navigation system. The incorporation of the traffic pattern data into the runtime database is implementation specific depending on the type of navigation system in the vehicle.

In block 516, the data in the runtime database is used to create a human-readable representation of the data, such as, for example, a map representative of map 300 in FIG. 3. As shown in FIG. 3, map 300 provides real-time traffic pattern data regarding highway traffic conditions to enable a driver to make intelligent choices in determining travel routes.

Returning to FIG. 5, vehicle and/or highway transponders may also desire information from the vehicle's wireless subsystem. In decision block 518, it is determined whether a request for data has been received. If a request for data has been received, the process proceeds to block 520.

In block 520, the vehicle's wireless subsystem responds with a traffic pattern packet based on the data in the current runtime database. In one embodiment, policy may dictate that only a small portion of the latest entries be sent to the requestor. In another embodiment, policy may dictate that half of the current entries be sent to the requestor. In yet another embodiment, policy may dictate that all entries be sent to the requestor. In one embodiment, the entries are sent to the requestor via a vehicle to highway packet, such as, but not limited to, vehicle to highway packet 420 in FIG. 4B. The requestor may be a highway transponder and/or another vehicle. The process then proceeds to decision block 522.

Returning to decision block 518, if it is determined that a request has not been received, the process proceeds to decision block 522.

In decision block 522, it is determined whether a predetermined timeout has elapsed. If a predetermined timeout has not elapsed, the process proceeds back to decision block 518 to determine whether a request for data has been received.

Returning to decision block 522, if a predetermined timeout has elapsed, the process proceeds to block 524. In block 524, the database is scanned for entries that are no longer relevant to a real-time traffic pattern. Such entries are pruned from the database. The entries are pruned based on a predetermined length of time (also referred to as stale time) in which information is stored in the database. If data has been stored in the database for at least, or longer, than the stale time, this data may be purged. For example, data collected two or more hours ago may have indicated that traffic on a particular highway was slow or had stopped. That data may now be totally useless. Thus, to prevent such data from being passed to other vehicle or highway transponders, such data may be purged from the database. The process then proceeds back to block 506 to continue to look for up-to-date traffic patterns, to provide the driver with up-to-date maps of traffic patterns, and to provide other vehicle and highway transponders with current traffic information.

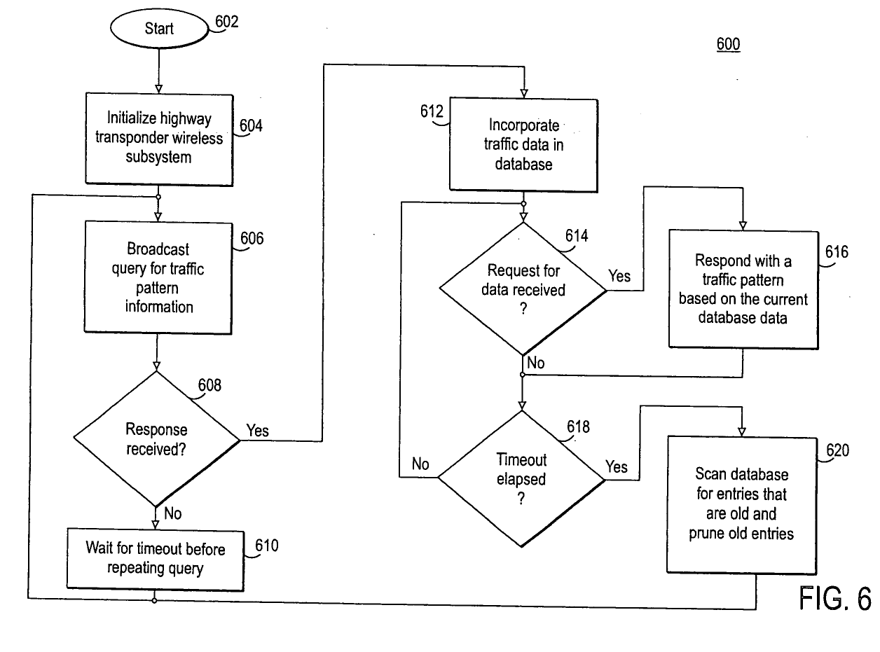

FIG. 6 is a flow diagram 600 describing an exemplary method for real-time traffic information management by a highway transponder wireless subsystem according to an embodiment of the present invention. The invention is not limited to the embodiment described herein with respect to flow diagram 600. Rather, it will be apparent to persons skilled in the relevant art(s) after reading the teachings provided herein that other functional flow diagrams are within the scope of the invention. The process begins with block 602, where the process immediately proceeds to block 604.

In block 604, the highway transponder wireless subsystem is initialized. The highway transponder wireless subsystem may include a plurality of highway transponders placed at pre-determined locations along a highway. A full initialization for the highway transponder wireless subsystem may be performed at installation. After installation, in one embodiment, a subsequent initialization process may be waking up a highway transponder from a resting state if no activity has occurred within a certain amount of time, scanning the data files and purging the stale data. Yet, in an embodiment where the highway transponder wireless subsystem never rests, a subsequent initialization process may consist of scanning the data in a highway transponder and purging all stale data at predetermined time intervals. The process then proceeds to block 606.

In block 606, a query is broadcast from a highway transponder to obtain a highway traffic pattern. Each highway transponder is searching for any information regarding highway traffic patterns from vehicles as well as other highway transponders.

In decision block 608, it is determined whether a response to the query was received. If a response has not been received, the process proceeds to block 610, where the process waits for a predetermined timeout to occur before proceeding back to block 606, where another query is broadcast.

Returning to decision block 608, if a response has been received, then the process proceeds to block 612.

In block 612, assuming that the data received is highway traffic pattern data, the highway traffic pattern data is incorporated into the highway transponder runtime database.

Vehicle and other highway transponders may also desire information from a highway transponder. In decision block 614, it is determined whether a request for data from another highway transponder and/or a vehicle has been received. If a request for data from another highway transponder and/or vehicle has been received, the process proceeds to block 616.

In block 616, the highway transponder responds with a traffic pattern packet based on the data in the current runtime database. In one embodiment, policy may dictate that only a small portion of the latest entries be sent to the requestor. In another embodiment, policy may dictate that half of the current entries be sent to the requestor. In yet another embodiment, policy may dictate that all entries be sent to the requestor. In one embodiment, the entries are sent to the requestor via a highway to vehicle packet, such as, but not limited to, highway to vehicle packet 400 in FIG. 4A. The requester may be another highway transponder and/or a vehicle. The process then proceeds to decision block 618.

Returning to decision block 614, if it is determined that a request has not been received, the process then proceeds to decision block 618.

In decision block 618, it is determined whether a predetermined timeout has elapsed. If the predetermined timeout has not elapsed, the process proceeds back to decision block 614 to determine whether a request for data has been received.

Returning to decision block 618, if the predetermined timeout has elapsed, the process proceeds to block 620. In block 620, the database is scanned for entries that are no longer relevant to a real-time traffic pattern. Such entries are pruned from the database in a similar manner as described above with reference to block 524 in FIG. 5. To prevent old data from being passed to other vehicle or highway transponders, such data may be purged from the runtime database. The process then proceeds back to block 606 to continue to look for up to date traffic patterns and to provide other vehicle and highway transponders with current traffic information.

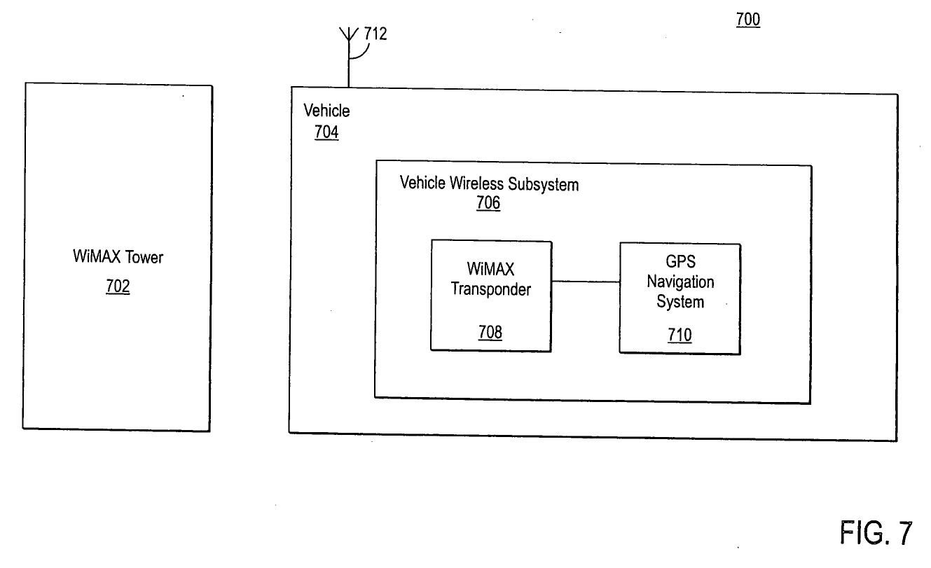

In another embodiment of the present invention, a WiMAX (short for Worldwide Interoperability for Microwave Access) deployment of the present invention may be used. WiMAX is a broadband technology based on the IEEE 802.16 standard. A WiMAX deployment of the present invention may consist of WiMAX towers or base stations (similar to cellular towers) that communicate with the vehicle wireless subsystems. In a WiMAX environment, a vehicle wireless subsystem may consist of a mobile WiMAX transponder coupled to a GPS (Global Positioning System) navigation system. The mobile WiMAX transponder communicates with the WiMAX towers via a WiMAX antenna. FIG. 7 is a block diagram of an exemplary WiMAX deployment according to an embodiment of the present invention. Shown in FIG. 7 are a WiMAX tower 702 and a vehicle 704 having a vehicle wireless subsystem 706. Vehicle wireless subsystem 706 comprises a mobile WiMAX transponder 708 coupled to a GPS navigation system 710. Mobile WiMAX transponder 706 includes a WiMAX antenna 712 (shown as part of vehicle 704).

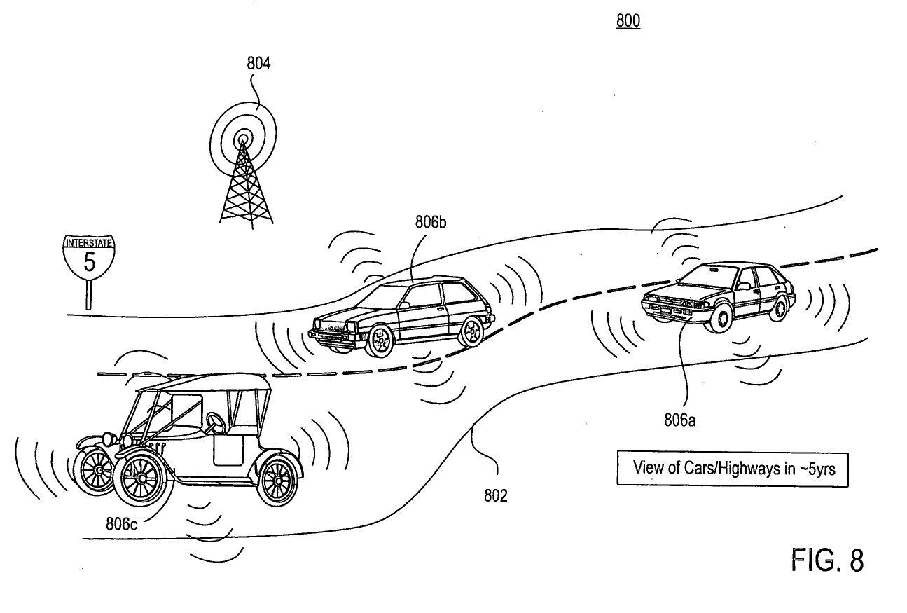

FIG. 8 is a block diagram illustrating another embodiment of an exemplary Intelligent Highway 800. Intelligent Highway 800 comprises a highway 802 with a plurality of WiMax towers 804 spaced at pre-determined distances along highway 802. Due to the spacing of WiMax towers, only one WiMax tower is shown in FIG. 8. According to WiMax or 802.16, WiMax towers may have an effective radius of approximately 30 miles. Therefore, WiMax towers may be spaced at approximately 30 miles apart. In comparison to the highway transponders described above, WiMax towers are spaced much farther apart than the highway transponders. Highway 802 also includes vehicles 806a, 806b, and 806c traveling along highway 802. Each of vehicles 806a, 806b, and 806c may include a vehicle wireless subsystem 706 located within vehicles 806a, 806b, and 806c that are capable of communicating with WiMax towers, such as WiMax tower 804.

Embodiments of the present invention enable WiMax towers 804 to communicate with vehicle wireless subsystems 706 installed in vehicles. Each WiMax tower 804 is capable of transmitting and receiving traffic data to and from each vehicle wireless subsystem 706 when vehicles 806a, 806b, and 806c come within an approximate 30 mile radius of WiMax tower 804. For example, when vehicles 806a, 806b, and 806c are within the radius of WiMax tower 804, vehicles 806a, 806b, and 806c, via vehicle wireless subsystems 706, may request that WiMax tower 804 provide them with current traffic pattern information stored on a runtime database of WiMax tower 804. Vehicles 806a, 806b, and 806c may also provide WiMAX tower 804 with current traffic pattern information stored on runtime databases of vehicles 806a, 806b, and 806c. The traffic pattern information obtained by vehicles 806a, 806b, and 806c may be incorporated on vehicle GPS navigation systems 710 to provide drivers with real-time traffic information to enable drivers to intelligently re-route their course based on traffic conditions. An exemplary map 300, described above with reference to FIG. 3, provides a snapshot of a vehicle navigation system display indicating free flowing, slow flowing, and little or no flowing traffic patterns on the highways that may be provided to a driver using a WiMAX intelligent highway system.

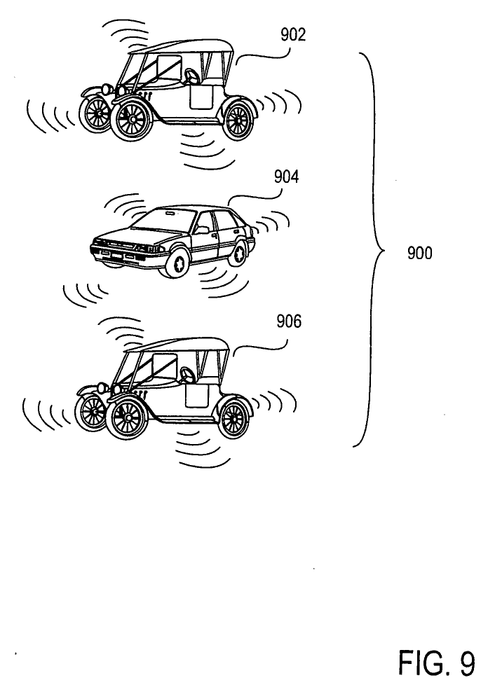

Due to the effective radius of approximately 30 miles for a WiMAX tower, the need for peer-to-peer communications between vehicles may not occur as often as with the highway transponder implementation. With that being said, peer-to-peer communications may still occur between vehicles by way of vehicle wireless subsystems 706. FIG. 9 is a diagram illustrating an exemplary method for passing locality status data from one vehicle to another in a WiMax environment according to an embodiment of the present invention. Diagram 900 shows three vehicles 902, 904, and 906 passing traffic pattern information from one vehicle to another. The traffic pattern information is passed from one vehicle to another by sending packets. For example, vehicle 902 is shown passing traffic pattern information to vehicle 904. Vehicle 904 is shown passing traffic pattern information to vehicles 902 and 906. Vehicle 906 is shown passing traffic pattern information to vehicle 904. Thus, vehicle 902 may pass information to vehicle 904 and vehicle 904 may pass information from both vehicles 902 and 904 to vehicle 906. Also, vehicle 906 may pass information to vehicle 904 and vehicle 904 may pass information from both vehicle 906 and vehicle 904 to vehicle 902.

In one instance, the passing of traffic pattern information from one vehicle to another in a WiMAX environment may occur when a vehicle is out of range of any WiMAX tower. Such an example may be when a vehicle is just leaving a garage and passes a vehicle that just came off of an intelligent highway having WiMAX towers. In this case, the vehicle just coming off of the intelligent highway may pass traffic pattern information to the vehicle just leaving the garage to update the driver of the traffic conditions on the intelligent highway.

Another instance in which the passing of traffic pattern information from one vehicle to another in a WiMAX environment may occur is when a vehicle encounters an area in which communication between a WiMAX tower and the vehicle is temporarily disabled due to a dead zone. This is analogous to dead zones with a cell tower and a cell phone. Although the vehicle is within the radius of the WiMAX tower, other extraneous interferences occur that prevent the vehicle and the WiMAX tower from communicating. In this instance, traffic pattern information may be passed from one vehicle to another to update the driver of the traffic conditions on the intelligent highway.

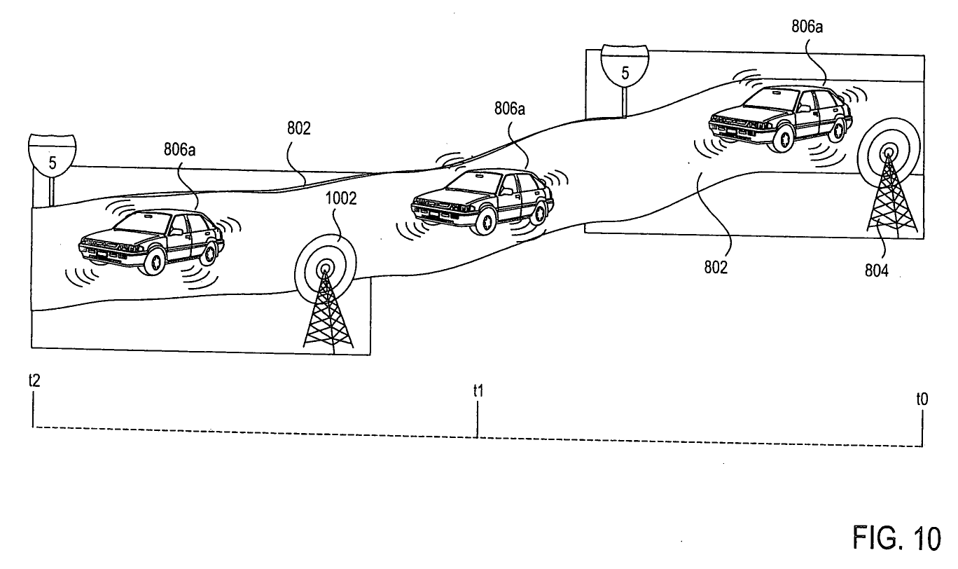

FIG. 10 is a diagram 1000 further illustrating the methods of operation for an intelligent highway 802 according to an embodiment of the present invention. Diagram 1000 illustrates vehicle 806a traveling on Interstate I5. At time t0, vehicle 806a is within the range of WiMAX tower 804. While vehicle 806a is within the range of WiMAX tower 804, vehicle 806a may send traffic pattern data currently in its runtime database to WiMAX tower 804. WiMAX tower 804 may also send vehicle 806a traffic pattern data currently in the runtime database of WiMAX tower 804. As vehicle 806a travels approximately 30 miles down Interstate I5, at time t1, WiMAX tower 804 is no longer within the range of vehicle 806a. At this time, vehicle 806a is within the range of WiMAX tower 1002. At this time, vehicle 806a may send WiMAX tower 1002 all of the current traffic pattern data that it received from WiMAX tower 804. WiMAX tower 1002 may also send vehicle 806a all of the current traffic pattern data that it has in its runtime database. This process of exchanging traffic pattern data between vehicle 806a and the WiMAX towers along Interstate I5 continues to occur along intelligent highway 802 until vehicle 806a exits intelligent highway 802.

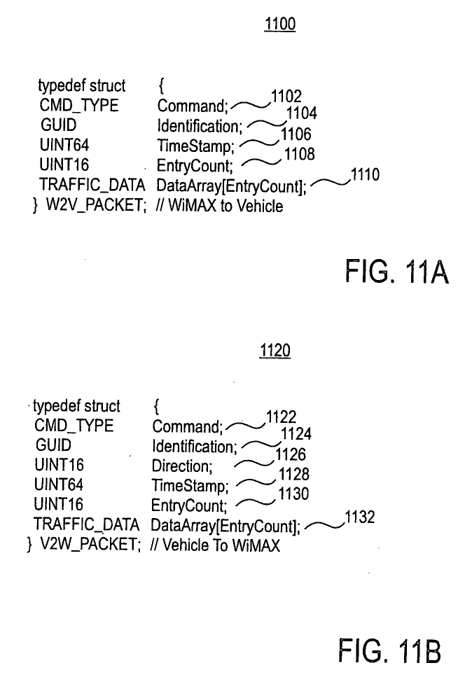

FIG. 11A is an exemplary type definition structure for a WiMax-to-vehicle packet according to an embodiment of the present invention. As its name implies, WiMAX-to-vehicle packet 1100 contains data from a WiMAX tower that is being sent to a vehicle wireless subsystem. The vehicle wireless subsystem then sends the information to a navigation system database to update a map, such as map 300, which displays the traffic patterns on the navigation system. In embodiments, WiMAX-to-vehicle packet 1100 may be used to transfer data between WiMAX towers if WiMAX tower radiuses happen to overlap.

In one embodiment, WiMAX-to-vehicle packet 1100 includes a command 1102, an identifier 1104, a timestamp 1106, an entry count 1108, and a data array 1110. Command 1102 may be, but is not limited to, a read or write command. For example, a WiMAX tower may request to read data from a vehicle wireless subsystem or to write data to a vehicle wireless subsystem. Identifier 1104 may be a unique identifier, such as, but not limited to, a GUID (Globally Unique Identifier), that identifies the WiMAX tower sending WiMAX-to-vehicle packet 1100. GUIDs are well known to those skilled in the relevant art(s). Timestamp 1106 may be the time at which the request is being made. Entry count 1108 may refer to the number of entries that are being sent in data array 1110. For example, if a WiMAX tower has 20 entries from other WiMAX towers and vehicle wireless subsystems, entry count 1108 will be 20. If the WiMAX tower has 100 entries from other WiMAX towers and vehicle wireless subsystems, entry count 1108 will be 100. Data array 1110 comprises an array of data that stores the traffic information retrieved from other WiMAX towers and vehicle wireless subsystems. In one embodiment, data array 1110 may include a timestamp indicating when the data from a particular WiMAX tower or vehicle wireless subsystem was initially retrieved. Including a timestamp with each entry of data enables data retrieved before a specific time to be purged from the database, thereby enabling the navigation system to map current data. Although WiMAX-to-vehicle packet 1100 is described containing five entries (1102, 1104, 1106, 1108, and 1110), these entries are provided as examples only. One skilled in the relevant art(s) would know that WiMAX-to-vehicle packet 1100 may contain more or less entries, as well as different types of entries, than those indicated above.

FIG. 11B is an exemplary type definition structure for a vehicle-to-WiMax packet according to an embodiment of the present invention. As its name implies, vehicle-to-WiMAX packet 1120 contains data from a vehicle wireless subsystem that is being sent to a WiMAX tower. In embodiments, vehicle-to-WiMAX packet 1120 may be used to transfer data between vehicle wireless subsystems as well.

Vehicle-to-WiMAX packet 1120 is very similar to WiMAX-to-vehicle packet 1100 with the exception of a direction field. In one embodiment, vehicle-to-WiMAX packet 1120 includes a command 1122, an identifier 1124, a direction 1126, a timestamp 1128, an entry count 1130, and a data array 1132. Command 1122 may be, but is not limited to, a read or write command. For example, a vehicle wireless subsystem may request to read data from a WiMAX tower or to write data to a WiMAX tower. Identifier 1124 may be a unique identifier, such as, but not limited to, a GUID, that identifies the vehicle wireless subsystem sending vehicle-to-WiMAX packet 1120. Direction 1126 may be the direction in which the vehicle is traveling. Timestamp 1128 may be the time at which the request is being made. Entry count 1130 may refer to the number of entries that are being sent in data array 1132. Data array 1132 comprises an array of data that stores the traffic information retrieved from other WiMAX towers and vehicle wireless subsystems. In one embodiment, data array 1132 may include a timestamp indicating when the data from a particular WiMAX tower or vehicle wireless subsystem was initially retrieved. As indicated above, including a timestamp with each entry of data enables data retrieved before a specific time to be purged from the database, thereby enabling the WiMAX towers to contain current data. Although vehicle-to-WiMAX packet 1120 is described containing six entries (1122, 1124, 1126, 1128, 1130, and 1132), these entries are provided as examples only. One skilled in the relevant art(s) would know that vehicle-to-WiMAX packet 1120 may contain more or less entries, as well as different types of entries, than those indicated above.

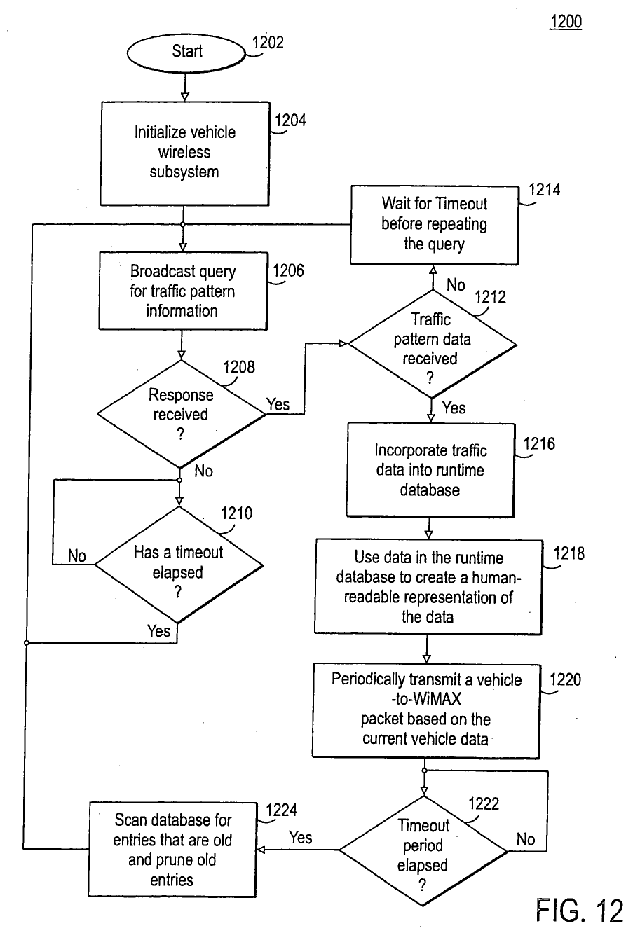

FIG. 12 is a flow diagram 1200 describing another exemplary method for real-time traffic information management by a vehicle wireless subsystem according to an embodiment of the present invention. The invention is not limited to the embodiment described herein with respect to flow diagram 1200. Rather, it will be apparent to persons skilled in the relevant art(s) after reading the teachings provided herein that other functional flow diagrams are within the scope of the invention. The process begins with block 1202, where the process immediately proceeds to block 1204.

In block 1204, on starting a vehicle, the vehicle's wireless communication system, which may include, inter alia, a vehicle wireless subsystem coupled to a GPS navigation system, is initialized. The vehicle's infrastructure is turned on and a self-test may be performed. The display for the navigation system may display a start-up screen. The components in the vehicle's wireless subsystem may be checked to determine if they are operating properly. The operating system will boot-up as well. Old or stale traffic files will be removed from the system. The process then proceeds to block 1206.

In block 1206, the vehicle wireless subsystem broadcasts a query for traffic pattern information. During this time the vehicle is searching for information regarding any highway traffic patterns that are available from a WiMAX tower or another vehicle. The process then proceeds to decision block 1208.

In decision block 1208, it is determined whether a response to the query has been received. If no response has been received and a timeout has elapsed (decision block 1210), the process proceeds back to block 1206, where another query for traffic pattern information is broadcast.

Returning to decision block 1208, if no response has been received and a timeout has not elapsed (decision block 1210), the process remains at decision block 1210 until a timeout has elapsed. Once a timeout has elapsed, the process proceeds back to block 1206, where another query for traffic pattern information is broadcast.

Returning back to decision block 1208, if a response to the query has been received, the process proceeds to decision block 1212. In decision block 1212, it is determined whether traffic pattern data has been received in response to the query. If traffic pattern data was not received, after a timeout has elapsed (block 1214) the process proceeds back to block 1206, where another query for traffic pattern information is broadcast.

Returning back to decision block 1212, if traffic pattern data is received, the process proceeds to block 1216. In block 1216, the traffic pattern data that was received is incorporated into a runtime database for the vehicle navigation system. The incorporation of the traffic pattern data into the runtime database is implementation specific depending on the type of navigation system installed in the vehicle. The process then proceeds to block 1218.

In block 1218, the data in the runtime database is used to create a human-readable representation of the data, such as, for example, a map representative of map 300 in FIG. 3. As previously indicated, map 300 provides real-time traffic pattern data regarding highway traffic conditions to enable the driver of the vehicle to make intelligent choices in determining travel routes. The process proceeds to block 1220.

In block 1220, the vehicle wireless subsystem periodically transmits vehicle-to-WiMAX traffic pattern packets in which traffic pattern data is sent to WiMAX towers, such as, for example, vehicle-to-WiMAX packet 1100, based on the current traffic pattern data in the vehicle runtime database. The process then proceeds to decision block 1222.

In decision block 1222, it is determined whether a predetermined timeout has elapsed. If a predetermined timeout has not elapsed, the process proceeds back to decision block 1222 to wait for a predetermined timeout to elapse. If a predetermined timeout has elapsed, the process proceeds to block 1224.

In block 1224, the runtime database is scanned for entries that are no longer relevant to a real-time traffic pattern. Such entries are pruned from the runtime database. The entries are pruned based on a predetermined length of time (also referred to as stale time) in which information is stored in the database. If data has been stored in the database for at least the length of stale time, the corresponding data may be purged. For example, data collected for an accident that occurred four hours ago on an Interstate highway in which traffic was halted may now be totally useless. Therefore, to prevent such stale data from being passed to other vehicles or WiMAX towers, the stale data may be purged from the runtime database. The process then proceeds back to block 1206 where the vehicle wireless subsystem broadcasts another query for traffic pattern information.

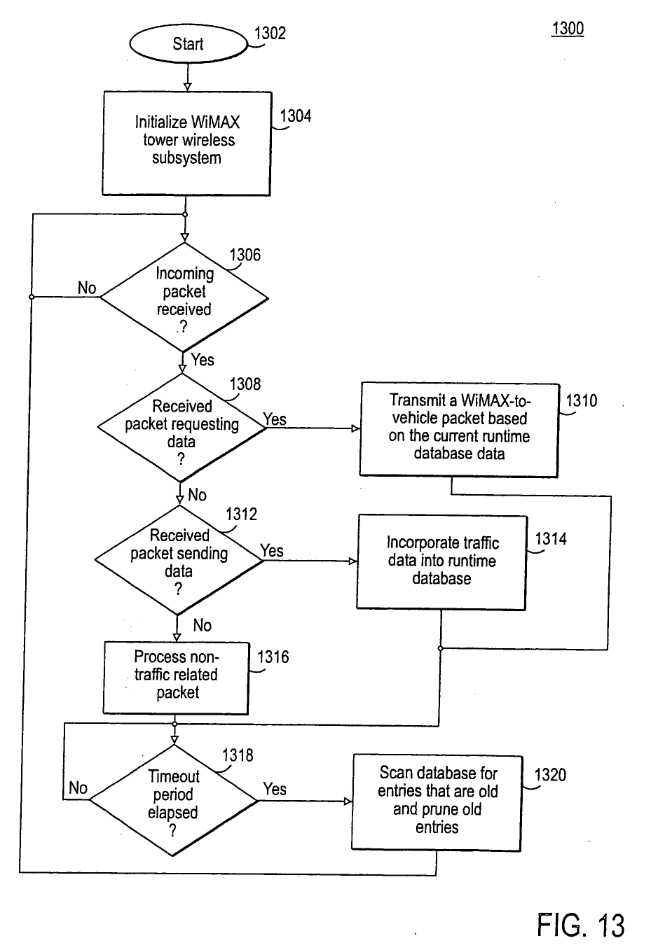

FIG. 13 is a flow diagram 1300 describing an exemplary method for real-time traffic information management by a WiMax tower according to an embodiment of the present invention. The invention is not limited to the embodiment described herein with respect to flow diagram 1300. Rather, it will be apparent to persons skilled in the relevant art(s) after reading the teachings provided herein that other functional flow diagrams are within the scope of the invention. The process begins with block 1302, where the process immediately proceeds to block 1304.

In block 1304, the WiMAX towers are initialized. The WiMAX towers are placed at pre-determined locations along a highway. As previously indicated, the spacing between WiMAX towers may be at least 30 miles apart for WiMAX towers that have an effective radius of approximately 30 miles. A full initialization for the WiMAX towers may be performed at installation. After installation, in one embodiment, a subsequent initialization process may occur if a WiMAX tower is reset or awakens from a resting state if no activity has occurred within a certain amount of time. This may include scanning the traffic pattern data in the running database for the WiMAX tower and purging any stale files. In an embodiment where the WiMAX tower never rests, a subsequent initialization process may consist of scanning the traffic pattern data in the WiMAX tower runtime database and purging any stale data at predetermined time intervals. The process then proceeds to decision block 1306.

In decision block 1306, it is determined whether a vehicle-to-WiMAX packet has been received. If a vehicle-to-WiMAX packet was received, the process proceeds to decision block 1308.

In decision block 1308, it is determined whether the received vehicle-to-WiMAX packet is a request for traffic pattern information. If the received vehicle-to-WiMAX packet is a request for traffic pattern information, the process then proceeds to block 1310. In block 1310, the WiMAX tower responds by transmitting a WiMAX-to-vehicle packet based on the current WiMAX tower traffic pattern data from the runtime database. The process then proceeds to decision block 1318.

Returning to decision block 1308, if it is determined that the received vehicle-to-WiMAX packet is not a request for traffic pattern information, the process proceeds to decision block 1312. In decision block 1312, it is determined whether the received vehicle-to-WiMAX packet is sending traffic pattern data to the WiMAX tower. If the received vehicle-to-WiMAX packet is sending traffic pattern data to the WiMAX tower, then the process proceeds to block 1314.

In block 134, the traffic pattern data for the WiMAX tower is extracted from the vehicle-to-WiMAX packet and incorporated into the runtime database of the WiMAX tower. The process then proceeds to decision block 1318.

The WiMAX tower may be performing numerous functions, and therefore, may receive packets that are non-traffic related packets. Returning to decision block 1312, if it is determined that the received vehicle-to-WiMAX packet is not sending traffic pattern data, then it may be that the received packet is not a vehicle-to-WiMAX packet, but a non-traffic related packet dealing with another function of the WiMAX tower. In this instance, the process proceeds to block 1316.

In block 1316, the WiMAX tower may process the non-traffic related packet. The process then proceeds to decision block 1318.

In decision block 1318, it is determined whether a predetermined timeout period has elapsed. If the predetermined timeout period has not elapsed, then the process remains at decision block 1318 until the predetermined timeout period has elapsed. If the predetermined timeout period has elapsed, then the process proceeds to block 1320.

In block 1320, the runtime database is scanned for entries that are no longer relevant to a real-time traffic pattern. Such entries are pruned from the runtime database. The entries are pruned based on a predetermined length of time (also referred to as stale time) in which information is stored in the runtime database. If data has been stored in the runtime database for at least the length of stale time, the corresponding data may be purged. For example, data collected two hours ago on an Interstate highway in which traffic was moving slowly due to construction on the highway that has now ended may be totally useless. Therefore, to prevent such stale data from being passed to other vehicles or WiMAX towers, the stale data may be purged from the runtime database. The process then proceeds back to block 1306 to determine whether a vehicle-to-WiMAX packet has been received at the WiMAX tower.

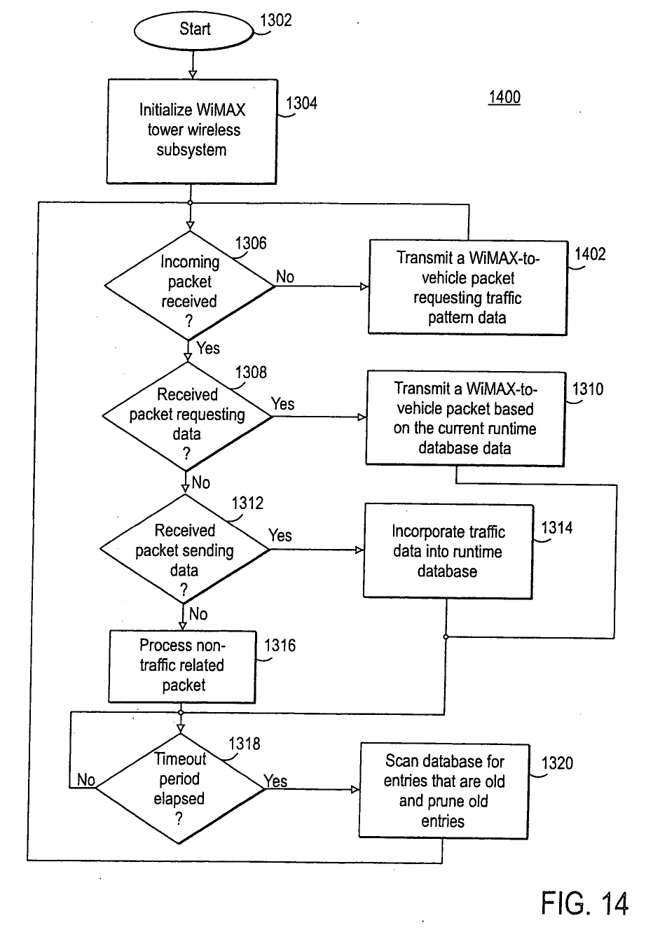

FIG. 14 is another flow diagram 1400 describing an exemplary method for real-time traffic information management by a WiMax tower according to an embodiment of the present invention. The invention is not limited to the embodiment described herein with respect to flow diagram 1400. Rather, it will be apparent to persons skilled in the relevant art(s) after reading the teachings provided herein that other functional flow diagrams are within the scope of the invention.

Flow diagram 1400 is similar to flow diagram 1300 with one exception. In decision block 1306, if it is determined that an incoming packet has not been received, then the WiMAX tower takes a proactive approach to obtaining traffic pattern information by transmitting a WiMAX-to-vehicle packet that requests traffic pattern data in block 1402. The process then proceeds back to decision block 1306 to determine whether an incoming packet has been received.

Although the invention has been described using highway transponders or WiMAX towers, it is conceivable that in some instances many highways may have both highway transponders and WiMAX towers. In such instances, the highway transponders may be used as a fault-tolerance mechanism when vehicles are in a dead zone of the WiMAX towers or out of range of the WiMAX towers. In other instances, the WiMAX towers may be used as a fault-tolerance mechanism when vehicles are unable to communicate with the highway transponders.

Certain aspects of embodiments of the present invention may be implemented using hardware, software, or a combination thereof and may be implemented in one or more computer systems or other processing systems. In fact, in one embodiment, the methods may be implemented in programs executing on programmable machines such as mobile or stationary computers, personal digital assistants (PDAs), set top boxes, cellular telephones and pagers, and other electronic devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that embodiments of the invention may be practiced with various computer system configurations, including multiprocessor systems, minicomputers, mainframe computers, and the like. Embodiments of the present invention may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for performing the methods, or by any combination of programmed computer components and custom hardware components. The methods described herein may be provided as a computer program product that may include a machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A traffic navigation method comprising:
initializing a vehicle wireless subsystem upon startup of a vehicle, the vehicle wireless subsystem including a mobile WiMAX transponder having a WiMAX antenna; and
enabling the vehicle wireless subsystem to:
broadcast a query to request real-time traffic pattern data;
upon receiving a response to the query, incorporate the real-time traffic pattern data into a vehicle runtime database; and
create a human-readable display using the vehicle runtime database for displaying on a navigation system, wherein the human-readable display provides a driver with up-to-date traffic conditions.

2. The method of claim 1, further comprising:
enabling the vehicle wireless subsystem to periodically transmit a vehicle-to-WiMAX packet based on current traffic pattern data from the vehicle runtime database to WiMAX towers; scan the vehicle runtime database for stale entries; and prune the stale entries.

3. The method of claim 1, wherein the up-to-date traffic conditions include at least one of free flowing traffic, slow traffic, and stopped traffic.

4. The method of claim 1, wherein the up-to-date traffic conditions comprise up-to-date highway traffic conditions.

5. The method of claim 1, wherein the real-time traffic pattern data comprises traffic pattern data received from at least one WiMAX tower.

6. The method of claim 1, wherein the real-time traffic pattern data comprises traffic pattern data received from other vehicles having the vehicle wireless subsystem when the WiMAX tower is out of range or a dead zone occurs.

7. The method of claim 1, wherein prior to incorporating the real-time traffic pattern data into the vehicle runtime database, determining whether the response to the query comprises the traffic pattern data; and if the response is not the traffic pattern data, then waiting for a predetermined timeout to expire; and broadcasting another query to request the real-time traffic pattern data.

8. The method of claim 1, further comprising enabling the vehicle wireless subsystem to continuously broadcast new queries to request the real-time traffic pattern data; continuously incorporate new real-time traffic pattern data into the vehicle runtime database and update the human-readable display for displaying on the navigation system based on the new real-time traffic pattern data; continuously send new vehicle-to-WiMAX packets based on new data in the vehicle runtime database; and continuously scan the vehicle runtime database to purge the stale entries.

9. A method for traffic navigation comprising:
initializing a WiMAX tower;
enabling the WiMAX tower to
determine whether an incoming packet has been received;
if the incoming packet has been received, determine whether the incoming packet is a request for traffic pattern data; and
if the incoming packet is a request for traffic pattern data, transmit a WiMAX-to-vehicle packet comprising real-time traffic pattern data.

10. The method of claim 9, further comprising enabling the WiMAX tower to scan a WiMAX runtime database for stale entries and purge the stale entries.

11. The method of claim 9, wherein if the incoming packet has not been received, enabling the WiMAX tower to wait until the incoming packet is received.

12. The method of claim 9, wherein if the incoming packet has not been received, enabling the WiMAX tower to transmit a WiMAX-to-vehicle packet requesting the real-time traffic pattern data and wait until the incoming packet is received.

13. The method of claim 9, wherein if the incoming packet is not a request for traffic pattern data, enabling the WiMAX tower to:
determine if the incoming packet includes the real-time traffic pattern data;
if the incoming packet does include the real-time traffic pattern data, incorporate the real-time traffic pattern data into the WiMAX runtime database;
scan the WiMAX runtime database for stale entries; and
purge the stale entries.

14. The method of claim 9, wherein if the incoming packet does not include the real-time traffic pattern data, enabling the WiMAX tower to:
accept the incoming packet as a non-traffic related packet;
process the non-traffic related packet;
scan the runtime database for stale entries; and
purge the stale entries.

15. The method of claim 9, further comprising enabling the WiMAX tower to:
continuously broadcast new queries to request the real-time traffic pattern data; continuously incorporate new real-time traffic pattern data received from the queries into the WiMAX runtime database; continuously send new WiMAX-to-vehicle packets based on new data in the WiMAX runtime database to requestors; and continuously scan the WiMAX runtime database to purge the stale entries.

16. A traffic navigation system comprising:
a plurality of WiMAX towers, each WiMAX tower dispersed on highways to transmit and receive traffic pattern data and WiMAX tower memory to store the traffic pattern data; and
a plurality of vehicle wireless subsystems, each vehicle wireless subsystem housed inside of a vehicle, each vehicle wireless subsystem including a WiMAX transponder having a WiMAX antenna to transmit and receive the traffic pattern data, vehicle memory to store the traffic pattern data, and a navigation system to display the traffic pattern data in a human readable format to a driver to enable the driver to view up-to-date traffic conditions.

17. The system of claim 16, wherein the display of the traffic pattern data in a human readable format includes the display of free-flowing traffic, slow moving traffic, and stopped traffic on a map to allow the driver to change a planned travel route if slow and stopped traffic pattern conditions exit on the planned travel route.

18. The system of claim 16, wherein the system enables peer-to-peer communications between the vehicle wireless subsystems to exchange current traffic pattern data when the WiMAX towers are out of range or a dead zone occurs.

19. The system of claim 16, wherein each WiMAX tower further comprises a processor, the processor configured to:
initialize the WiMAX tower;
enable the WiMAX tower to broadcast WiMAX-to-vehicle packets to obtain the traffic pattern data;
incorporate the traffic pattern data received from the vehicle wireless subsystems into a WiMAX runtime database;
share the traffic pattern data in the WiMAX runtime database with the vehicle wireless subsystems by enabling the WiMAX tower to transmit WiMAX-to-vehicle packets;
scan the WiMAX runtime database for stale data; and
purge the stale data.

20. The system of claim 18, wherein each vehicle wireless subsystem further comprises a processor, the processor configured to:
initialize the vehicle wireless subsystem;
enable the vehicle WiMAX transponders to broadcast vehicle-to-WiMAX packets to obtain the traffic pattern data;
incorporate the traffic pattern data received from the WiMAX towers and other vehicle wireless subsystems into a vehicle runtime database;
display the traffic pattern data in a human readable format on the navigation system;
share the traffic pattern data in the vehicle runtime database with the WiMAX towers and other vehicle wireless subsystems by enabling the vehicle wireless subsystem to transmit a vehicle-to-WiMAX packet comprising real-time traffic pattern data;
scan the vehicle runtime database for stale data; and
purge the stale data.

21. An article comprising: a storage medium having a plurality of machine accessible instructions, wherein when the instructions are executed by a processor, the instructions provide for initializing a vehicle wireless subsystem upon startup of a vehicle, the vehicle wireless subsystem including a mobile WiMAX transponder having a WiMAX antenna; and
enabling the vehicle wireless subsystem to:
broadcast a query to request real-time traffic pattern data;
upon receiving a response to the query, incorporate the real-time traffic pattern data into a vehicle runtime database; and
create a human-readable display using the vehicle runtime database for displaying on a navigation system, wherein the human-readable display provides a driver with up-to-date traffic conditions.

22. The article of claim 21, further comprising instructions for:
enabling the vehicle wireless subsystem to periodically transmit a vehicle-to-WiMAX packet based on current traffic pattern data from the vehicle runtime database to WiMAX towers; scan the vehicle runtime database for stale entries; and prune the stale entries.

23. The article of claim 21, wherein the up-to-date traffic conditions include at least one of free flowing traffic, slow traffic, and stopped traffic.

24. The article of claim 21, wherein the up-to-date traffic conditions comprise up-to-date highway traffic conditions.

25. The article of claim 21, wherein the real-time traffic pattern data comprises traffic pattern data received from at least one WiMAX tower.

26. The article of claim 21, wherein the real-time traffic pattern data comprises traffic pattern data received from other vehicles having the vehicle wireless subsystem when the WiMAX tower is out of range or a dead zone occurs.

27. The article of claim 21, wherein prior to providing instructions for incorporating the real-time traffic pattern data into the vehicle runtime database, providing instructions for determining whether the response to the query comprises the traffic pattern data; and if the response is not the traffic pattern data, then waiting for a predetermined timeout to expire; and broadcasting another query to request the real-time traffic pattern data.

28. The article of claim 21, further comprising instructions for enabling the vehicle wireless subsystem to continuously broadcast new queries to request the real-time traffic pattern data; continuously incorporate new real-time traffic pattern data into the vehicle runtime database and update the human-readable display for displaying on the navigation system based on the new real-time traffic pattern data; continuously send new vehicle-to-WiMAX packets based on new data in the vehicle runtime database; and continuously scan the vehicle runtime database to purge the stale entries.

29. An article comprising: a storage medium having a plurality of machine accessible instructions, wherein when the instructions are executed by a processor, the instructions provide for initializing a WiMAX tower;
enabling the WiMAX tower to
determine whether an incoming packet has been received;
if the incoming packet has been received, determine whether the incoming packet is a request for traffic pattern data; and
if the incoming packet is a request for traffic pattern data, transmit a WiMAX-to-vehicle packet comprising real-time traffic pattern data.

30. The article of claim 29, further comprising instructions for enabling the WiMAX tower to scan a WiMAX runtime database for stale entries and purge the stale entries.

31. The article of claim 29, wherein if the incoming packet has not been received, further providing instructions for enabling the WiMAX tower to wait until the incoming packet is received.

32. The article of claim 29, wherein if the incoming packet has not been received, further comprising instructions for enabling the WiMAX tower to transmit a WiMAX-to-vehicle packet requesting the real-time traffic pattern data and wait until the incoming packet is received.

33. The article of claim 29, wherein if the incoming packet is not a request for traffic pattern data, further comprising instructions for enabling the WiMAX tower to:
determine if the incoming packet includes the real-time traffic pattern data;
if the incoming packet does include the real-time traffic pattern data, incorporate the real-time traffic pattern data into the WiMAX runtime database;
scan the WiMAX runtime database for stale entries; and
purge the stale entries.

34. The article of claim 29, wherein if the incoming packet does not include the real-time traffic pattern data, further comprising instructions for enabling the WiMAX tower to:
accept the incoming packet as a non-traffic related packet;
process the non-traffic related packet;
scan the runtime database for stale entries; and
purge the stale entries.

35. The article of claim 29, further comprising instructions for enabling the WiMAX tower to:
continuously broadcast new queries to request the real-time traffic pattern data;
continuously incorporate new real-time traffic pattern data received from the queries into the WiMAX runtime database;
continuously send new WiMAX-to-vehicle packets based on new data in the WiMAX runtime database to requesters; and
continuously scan the WiMAX runtime database to purge the stale entries.
